(19) United States
(12) Patent Application Publication
(10) Pub. No.: US 2010/0216107 A1
(43) Pub. Date: Aug. 26, 2010

(54) System and Method of Distance Learning at Multiple Locations Using the Internet

(76) Inventor: Tony Hines, Tampa, FL (US)

Correspondence Address: McKinney Law, LLC, 121 S. Orange Ave, Suite 1500, Orlando, FL, 32801, US

(21) Appl. No.: 12/711,138

(22) Filed: Feb. 23, 2010

Related U.S. Application Data
(60) Provisional application No. 61/208,338, filed on Feb. 23, 2009.

(51) Int. Cl. G09B 5/00; G09B 7/00

(52) U.S. Cl. 434/307 R; 434/362

(57) ABSTRACT

A system of distance learning at multiple locations using the Internet is disclosed. In a particular embodiment, the system includes a student computer, a remote server, a student Internet connection between the student computer and the remote server, an instructor computer, an instructor Internet connection between the instructor computer and the remote server, and learning material, wherein the student computer and the instructor computer are configured to transmit and receive the learning material during a learning material session. In addition, the system includes an instructor tablet computer configured to transmit handwritten notes written thereon, and a learning material platform, where the learning material platform is configured to capture images of the learning material to transmit to the instructor computer. The learning material platform is configured to project the handwritten notes received from the instructor tablet computer over the learning material to provide visual instruction to a student.

### I. CROSS REFERENCE TO RELATED APPLICATIONS

This application claims the benefit of U.S. Provisional Application No. 61/208,338 filed Feb. 23, 2009. The disclosure of the provisional application is incorporated herein by reference.

### II. FIELD

The present disclosure is generally related to a system and method of distance learning at multiple locations using the Internet.

### III. DESCRIPTION OF RELATED ART

Many students benefit through tutoring in addition to the curriculum provided by public and private schools. However, there are not enough qualified tutors/instructors for all areas and neighborhoods to service all students. Accordingly, there is a need for a system and method of distance learning that allows tutors and instructors to be accessed from almost anywhere in the world to see and share the learning materials as though the tutor/instructor and student are in the same location to provide a one-on-one, face-to-face tutoring. There is also a need to eliminate the cost and the time associated with the travel that the student or the tutor/instructor has to spend in attending a tutoring, instructional or learning session.

In addition, a tutor/instructor may not have access to the relevant educational materials prior to a particular tutoring session since a tutor may cover many different fields and levels. This takes time away from the tutoring session as well as the tutor/instructor will not be able to provide the proper preparation for the tutoring of the student. Accordingly, there is a need for a more comprehensive distant learning system and method that includes sharing learning materials between remote locations over the Internet.

However, in view of the prior art at the time the present invention was made, it was not obvious to those of ordinary skill in the pertinent art how the identified needs could be fulfilled.

### IV. SUMMARY

In a particular embodiment, a method of distance learning at multiple locations using the Internet is disclosed. The method includes connecting a student computer to a remote server, initiating a learning material session using the remote server, determining whether an instructor computer is connected to the remote server, transmitting an image of learning material on a student learning platform when the instructor computer is connected to the remote server, projecting images received from an instructor tablet computer over the learning material on the student learning platform, transmitting student audio and video signals, receiving instructor audio and video signals, and terminating the connection between the student computer to the remote server when the learning material session is complete. The connection between the student computer and the remote server is a student Internet connection, where the student Internet connection is wired or wireless. The method also includes displaying a real-time video of an instructor contemporaneously with projecting images received from the instructor tablet computer and storing the student audio and video signals and the instructor audio and video signals.

In another particular embodiment, the method includes connecting an instructor computer to a remote server, initiating a learning material session using the remote server, determining whether a student computer is connected to the remote server, receiving an image of learning material on a student learning platform when the student computer is connected to the remote server, transmitting images from an instructor tablet computer to the student learning platform, receiving student audio and video, transmitting instructor audio and video signals, and terminating the connection between the instructor computer to the remote server when the learning material session is complete. The connection between the instructor computer and the remote server is an instructor Internet connection, where the instructor Internet connection is wired or wireless. Further, method includes displaying a real-time video of a student contemporaneously with receiving images from the learning material platform and analyzing the student audio and video signals and the instructor audio and video signals that were stored.

In another particular embodiment, a system of distance learning at multiple locations using the Internet is disclosed. The system includes a student computer, a remote server, a student Internet connection between the student computer and the remote server, an instructor computer, an instructor Internet connection between the instructor computer and the remote server, and learning material, wherein the student computer and the instructor computer are configured to transmit and receive the learning material during a learning material session. In addition, the system includes an instructor tablet computer, where the tablet computer is configured to transmit handwritten notes written thereon, and a learning material platform, where the learning material platform is configured to capture images of the learning material to transmit to the instructor computer. The student computer and the instructor computer are configured to receive and transmit audio and video signals. The learning material platform is configured to project the handwritten notes received from the instructor tablet computer over the learning material to provide visual instruction to a student. Further, the learning material platform includes an imaging device remotely controlled by an instructor. Also, the system may include a plurality of student computers and instructor computers connected to the remote server and configured to transmit and receive audio and video signals during the learning material session.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a particular illustrative embodiment of a system of distance learning at multiple locations using the Internet;

FIG. 2 is a flow chart of a particular illustrative embodiment of a method of distance learning at multiple locations using the Internet and an Instructor Mobile Internet Tutoring System (IMITS);

FIG. 3 is a flow chart of a particular illustrative embodiment of a method of distance learning at multiple locations using the Internet and a Student Mobile Internet Tutoring System (SMITS); and

FIG. 4 is a block diagram of an illustrative embodiment of a general computer system.

### VI. DETAILED DESCRIPTION

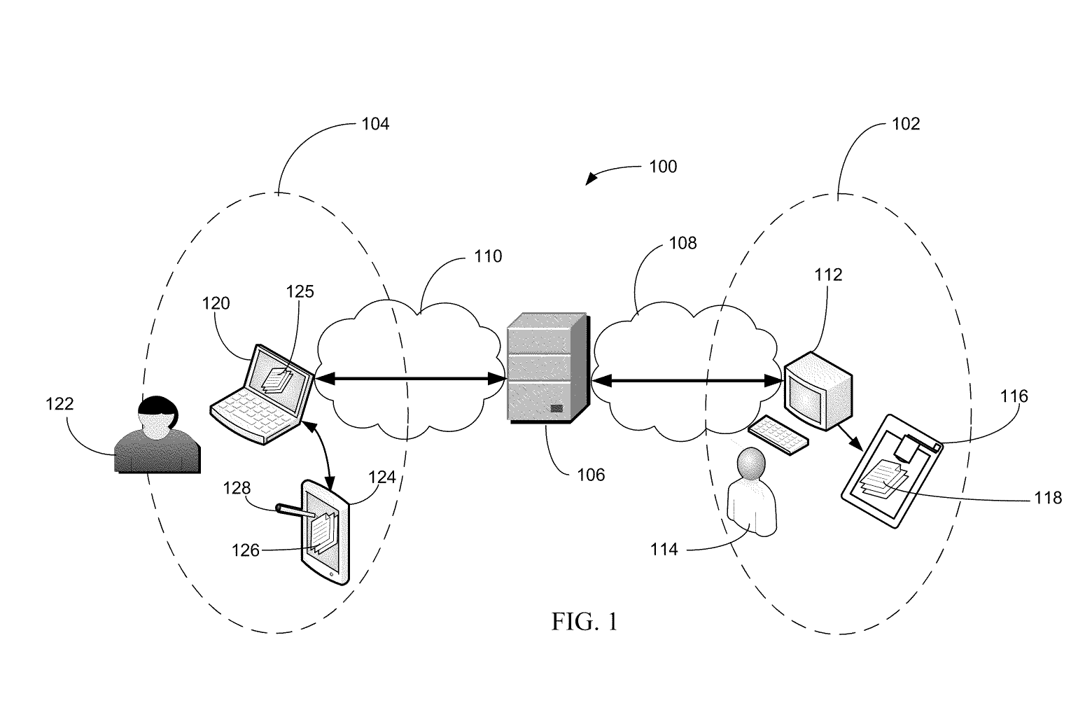

Referring now to FIG. 1, the system of distance learning at multiple locations using the Internet is generally designated 100. The system includes a Student Mobile Internet Tutoring System (SMITS) 102 and an Instructor Mobile Internet Tutoring System (IMITS) 104. The SMITS 102 includes a student personal computer 112 that is connected to a remote server 106 using a student Internet connection 108. The student Internet connection 108 may be wired, wireless or a cellular means of acquiring Internet connectivity.

As explained below, the remote server 106 may store particular computer executable instructions to manage the learning material session between the instructor 122 and the student 114. The IMITS 104 includes an instructor computer 120 that is connected to the remote server 106 using an instructor Internet connection 110. The instructor Internet connection 110 may be wired, wireless or a cellular means of acquiring Internet connectivity. The IMITS 104 and the SMITS 102 allows an instructor 122 and a student 114 to interact with one another on a real-time basis. This is accomplished through the use of streaming live video and audio that allows the instructor 122 to communicate with the student 114 as though they were in the same physical location. The SMITS 102 requires minimal training to operate and without adult help or supervision. The computer 112 of the SMITS may be a notebook or laptop computer that is light and portable enough for a small child to take home on a school bus and would fit in a school back pack.

For example, the student prepares to begin a learning material session at home by sitting at his or her student computer 112 that is set up in a convenient study place, possibly a desk or a kitchen table. He or she powers on the student computer 112. The power supply may be a wall powered outlet or the student computer 112 may be operated on battery power. The student 112 presses an activation button to log on to the remote server over the student Internet connection 108 to begin the learning material session. The student computer 112 waits for the instructor 122 to connect to the remote server 106 and log on to begin the learning material session. Once the instructor 122 is connected and logged on the learning material session, he or she may take control of the SMITS and begin interacting and supervising the student 114 during the learning material session as described below. The instructor 122 may log on to the learning material session using the instructor Internet connection 110 from any location the Internet is available.

The instructor computer 120 may have a microphone to capture audible instructions for the student 114. Accordingly, the instructor 122 can speak to the student 114 and tutor the student 114 verbally. In addition, the instructor computer 120 may have a speaker to broadcast audible communications from the student 114 who may be requested to answer questions from the instructor 122, for example. A video camera may also be provided on the instructor computer 120 to transmit visual images from the instructor 122 to the student 114. Similarly, the student computer 112 may have a video camera to transmit video images from the student 114 to the instructor 122. The audio and video transmissions are in real-time to provide immediate responses and enhance the interaction between the instructor 122 and the student 114.

As part of the system 100, the student may place selected learning material 118 i.e., homework book or text book, on a student learning platform 116. The learning material 118 is captured by an imaging device on the student learning platform 116 and an image of the learning material 118 is transmitted to the instructor 122. The learning material 118 is then displayed on the instructor computer 120 as learning material image 125. In addition, the learning material 118 may be displayed on an instructor tablet computer 124 as tablet image 126. The imaging device of the student learning platform 116 may be a variable position camera or similar type of imaging unit. The imaging device may be electronically, optically or mechanically focused. In addition, the imaging device may be repositioned by electronic or mechanical means. For example, a common focusing and magnification lens may be used by the imaging device to provide the optimum view of the learning material 118. The mechanical adjustment of the imaging device may be accomplished by moving a positioning arm along a track of the student learning platform 116. The adjustment of the imaging device may also be accomplished by a motor drive mechanism to control the positioning arm that may be remotely controlled by the instructor 122. The positioning arm may also be adjusted up and down via a manual vertical adjustment pin. In addition, the vertical adjustment of the positioning arm may be accomplished by a motor drive mechanism that could be remotely positioned by the instructor 122. The student learning platform 116 may have buttons to activate the power source as well as provide positioning controls for the imaging device. The student learning platform 116 also includes an image projector. The image projector may project an image from the instructor's 122 tablet computer 124 over the learning material 118 placed on the learning material platform 116. The image projector may be a Digital Light Projector (DLP) or a miniature video projector that accepts computer data as input.

The student computer 112 includes a display monitor to provide visual information to the student. The student computer 112 may also include a video camera to transmit images of the student 114 to the instructor 122. In addition, the student computer 112 may include a microphone to capture audible communications from the student 114 to transmit to the instructor 122. A speaker may also be provided so that the student 114 can hear the instructor's 122 questions and instructions. The student computer 112 may display an image of the instructor 122 and other relevant information for the learning session. The student learning platform 116 may include a means of storing the images used by the student learning platform 116 such as the images that are transmitted by the imaging device to the instructor 122 and the images that were received from the instructor 122 and projected by the image projector. The storage means may be a secured digital card, a thumb-drive, or other similar storage devices known in the art. In addition, the remote server may store the learning material sessions that have been completed. The stored learning material sessions may be used at a later date by the student 114 for reinforcement of the materials covered. Further, an official or supervisor, for example, may access the stored learning material sessions to review and critique the instructor 122 and learning material sessions.

The instructor tablet computer 124 may include a liquid crystal display to display the images of the learning material 116. The tablet computer 124 may also replace the instructor computer 120 and be used to access the remote server 106 directly. The instructor 122 may illustrate the correct method to solve a problem that a student 114 is working on by using the stylus 128 to illustrate onto the display. The instructor illustration is then transmitted to the student computer 112. The instructor illustration may be updated in real-time or may be static. The instructor illustration may be displayed on the student computer 112, the student learning platform 118, or any combination thereof. The system 100 may include a set of instructions that can be executed to cause the remote server 106, the student computer 112, the instructor computer 120, or any combination thereof, to perform any one or more of the methods or computer based functions disclosed herein.

The system 100 allows Internet communication with the IMITS over the instructor Internet connection 110 and with the SMITS over the student Internet connection 108. Further, the system 100 allows the instructor 122 to control the learning material session from the IMITS. The system provides for the full capture of the learning material 119 remotely by the instructor 122 from the IMITS. The instructor 122 may capture selected parts of the learning material 118 and display this information on the IMITS. In addition, an instructor 122 may focus/zoom and pan to the learning material remotely to select the best view of the learning material. A tablet computer 124, touch-screen, or pen input tablet, may be used to transmit material or illustrations to the student 114 for viewing. Another feature of the system 100 is that a student 114 may view material from more than one tutor/instructor and may bring in more than one tutor/instructor to a learning session. Accordingly, a specialist may participate for a part of the learning session with a student 114. For example, an engineering instructor made need to bring in a math or physics expert to aid in a particular learning session. The system 100 stores the data from the learning session on the remote server 106 for replay and evaluation. Further, the system 100 provides for instructors from all over the world to enter their names and their respective special skills into a central database that can be accessed by educators and students from all over the world. Accordingly, multiple students may work with one instructor. Accordingly, this feature will provide multiple students an opportunity to share the cost and resources of the tutoring or instructional learning session.

For example, the student 114 and the instructor 122 may be at two different physical locations. The student 114 and the instructor 122 both log onto the remote server 106. The student places his or her learning material 118 upon the learning material platform 116. The learning material platform 116 captures an image (and/or video) of the learning material 118 through the learning material platform 116 and transfers the image to the student computer 112. The student computer 1112 is connected to the student Internet connection 108, which is used to transmit the image (and/or video) and other data to the remote server 106. The remote server 106 may handle, store and manage the various data transmitted and received between the SMITS 102 and the IMITS 104. The remote server 106 transmits the data over the instructor Internet connection 110 to the instructor computer 120. The instructor computer 120 and/or tablet computer 124 displays the image of the student learning material 126. The student computer 112 may include a camera that captures video of the student 114 and transmits (e.g., streams) the video to the instructor computer 120 in real-time. The instructor computer 120 may also transmit the image of the learning material 126 onto a tablet computer 124 such that the instructor 122 can use a stylus 128 to write information onto the learning material 126 that is being displayed. The instructor 122 can use the stylus 128 to overlay handwritten information. The information that is written onto the tablet computer 124 by the stylus 128 is transmitted and displayed on the student computer 112. In addition, the information may also be projected onto the learning material 118 in real-time. This projection is beamed on top of the learning material 118 so as the instructor 122 writes on her tablet computer 124, the information is displayed as a projected image onto the learning material 118. The instructor 122 may also select any type of image that he or she can transmit from the instructor computer 120 and have it projected onto the learning material 118 and/or displayed on the student computer 112. The student 112 and instructor 122 may interact during the learning session using respective microphones, speakers and video cameras. As the student 114 writes or points to a part of the learning material 118, real-time video of the student's action may be transmitted to IMITS. Accordingly, the instructor 122 can view the content and changes of content that is placed on the learning material platform. In addition, the learning material platform 116 may project an image and/or video on a screen or a wall to visually illustrate information to multiple students at one time.

In another exemplary illustration of an advantage of the system 100, an object may be placed on the learning material platform 116 and instructions may be provided remotely to illustrate how a procedure is to be performed, how to operate a piece of equipment, where a problem is located, how to solve the problem and even projected onto a surgery that is being performed to help or teach a surgical procedure.

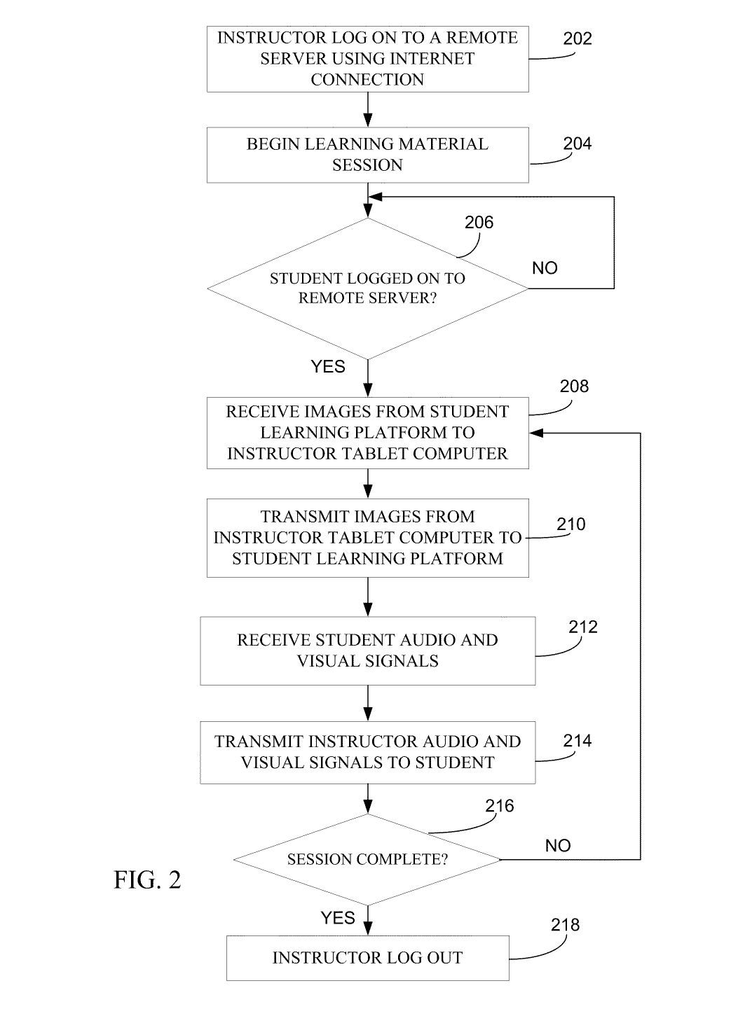

FIG. 2 is a flow chart of a particular illustrative embodiment of the IMITS that may be used with the method of distance learning at multiple locations using the Internet. One or more servers, such as the remote server 106 of FIG. 1, may execute the method. At 202, an instructor logs on to a remote server using an Internet connection. Proceeding to 204, a learning material session begins. Moving to 206, if a designated student is logged on to the remote server, then the instructor begins to receive images from the student learning platform on the instructor tablet computer at 208. If no designated student is logged on to the remote server, then the instructor waits until the designated student logs in to the remote server. At 210, images are transmitted from the instructor tablet to the student learning platform. The instructor receives, at 212, student audio and visual signals (e.g., video). The instructor responds, at 214, and transmits instructor audio and visual signals (e.g., video) to the student. If the session is complete, at 216, then the instructor logs out from the remote server, at 218, otherwise, the student and instructor continue to interact with one another until the session is complete.

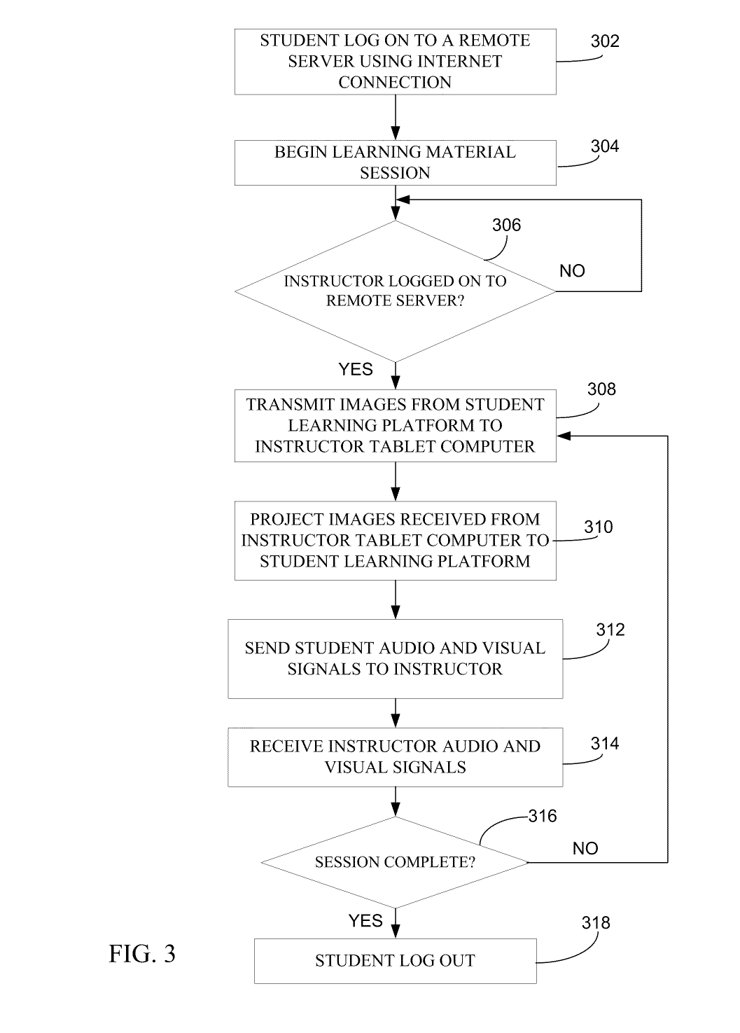

Referring now to FIG. 3, a particular illustrative embodiment of a SMITS that may be used with the method of distance learning at multiple locations using the Internet is disclosed. At 302, the student logs on to the remote server using an Internet connection. Proceeding to 304, a learning material session begins. Moving to 306, if the designated instructor is logged on to the remote server, then the student begins to transmit images from the student learning platform to the instructor tablet computer at 308. If the designated instructor is not logged on to the remote server, then the student waits until the designated instructor logs in to the remote server. Images (e.g., video) received from the instructor tablet are projected to the student learning platform, at 310. The student, at 312, transmits student audio and visual signals (e.g., video) to the instructor. The student, at 314, receives instructor audio and visual signals (e.g., video). If the session is complete, at 318, then the student logs out from the remote server, at 318, otherwise, the student and instructor continue to interact with one another until the session is complete.

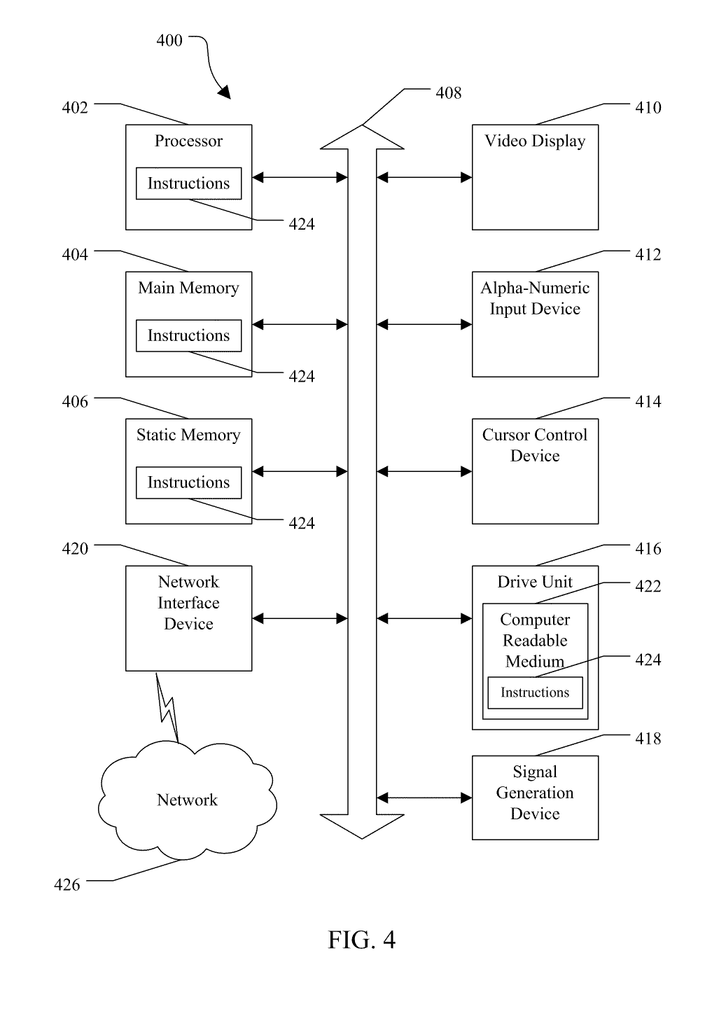

Referring to FIG. 4, an illustrative embodiment of a general computer system is shown and is designated 400. The computer system 400 can include a set of instructions that can be executed to cause the computer system 400 to perform any one or more of the methods or computer based functions disclosed herein. The computer system 400, or any portion thereof, may operate as a standalone device or may be connected, e.g., using a network, to other computer systems or peripheral devices, including a remote server as shown in FIG. 1.

In a networked deployment, the computer system may operate in the capacity of a server, such as a video server or application server, or a media device. The computer system 400 can also be implemented as or incorporated into various devices, such as a personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics-processing unit (GPU), or both. Moreover, the computer system 400 can include a main memory 404 and a static memory 406 that can communicate with each other via a bus 408. As shown, the computer system 400 may further include a video display unit 410, such as a liquid crystal display (LCD), a flat panel display, a solid-state display, or a cathode ray tube (CRT). Additionally, the computer system 400 may include an input device 412, such as a keyboard, and a cursor control device 414, such as a mouse or stylus. The computer system 400 can also include a disk drive unit 416, a signal generation device 418, such as a speaker, video camera, or remote control, and a network interface device 420.

In a particular embodiment, as depicted in FIG. 4, the disk drive unit 416 may include a computer-readable medium 422 in which one or more sets of instructions 424, e.g. software, can be embedded. Further, the instructions 424 may embody one or more of the methods or logic as described herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined by the following claims.

What is claimed is:

1. A method of distance learning at multiple locations using the Internet, the method comprising:
connecting a student computer to a remote server;
initiating a learning material session using the remote server;
determining whether an instructor computer is connected to the remote server;
transmitting an image of learning material on a student learning platform when the instructor computer is connected to the remote server;
projecting images received from an instructor tablet computer over the learning material on the student learning platform;
transmitting student audio and video signals;
receiving instructor audio and video signals; and
terminating the connection between the student computer to the remote server when the learning material session is complete.

2. The method of claim 1, wherein the connection between the student computer to the remote server is a student Internet connection.

3. The method of claim 2, wherein the student Internet connection is wired or wireless.

4. The method of claim 3, further comprising displaying a real-time video of an instructor contemporaneously with projecting images received from the instructor tablet computer.

5. The method of claim 4, further comprising storing the student audio and video signals and the instructor audio and video signals.

6. A method of distance learning at multiple locations using the Internet, the method comprising:
connecting an instructor computer to a remote server;
initiating a learning material session using the remote server;
determining whether a student computer is connected to the remote server;
receiving an image of learning material on a student learning platform when the student computer is connected to the remote server;
transmitting images from an instructor tablet computer to the student learning platform;
receiving student audio and video;
transmitting instructor audio and video signals; and
terminating the connection between the instructor computer to the remote server when the learning material session is complete.

7. The method of claim 5, wherein the connection between the instructor computer to the remote server is an instructor Internet connection.

8. The method of claim 7, wherein the instructor Internet connection is wired or wireless.

9. The method of claim 8, further comprising displaying a real-time video of a student contemporaneously with receiving images from the learning material platform.

10. The method of claim 9, further comprising analyzing the student audio and video signals and the instructor audio and video signals that were stored.

11. A system of distance learning at multiple locations using the Internet, the system comprising:
a student computer;
a remote server;
a student Internet connection between the student computer and the remote server;
an instructor computer;
an instructor Internet connection between the instructor computer and the remote server; and
learning material, wherein the student computer and the instructor computer are configured to transmit and receive the learning material during a learning material session.

12. The system of claim 11, further comprising an instructor tablet computer, wherein the tablet computer is configured to transmit handwritten notes written thereon.

13. The system of claim 12, further comprising a learning material platform, wherein the learning material platform is configured to capture images of the learning material to transmit to the instructor computer.

14. The system of claim 13, wherein the learning material is a selected text book.

15. The system of claim 14, wherein the student computer is configured to receive and transmit audio and video signals.

16. The system of claim 15, wherein the instructor computer is configured to receive and transmit audio and video signals.

17. The system of claim 16, wherein the learning material platform is configured to project the handwritten notes received from the instructor tablet computer over the learning material to provide visual instruction to a student.

18. The system of claim 17, wherein the learning material platform further comprising an imaging device remotely controlled by an instructor.

19. The system of claim 11, further comprising a plurality of student computers connected to the remote server and configured to transmit and receive audio and video signals during the learning material session.

20. The system of claim 11, further comprising a plurality of instructor computers connected to the remote server and configured to transmit and receive audio and video signals during the learning material session.
